(19) United States
(12) Patent Application Publication
(10) Pub. No.: US 2009/0260203 A1
(43) Pub. Date: Oct. 22, 2009

(54) CADAVER BAG FOR ANIMALS

(76) Inventor: Jon Baumhauer, Piqua, OH (US)

Correspondence Address: MCNEES WALLACE & NURICK LLC, 100 PINE STREET, P.O. BOX 1166, HARRISBURG, PA, 17108-1166, US

(21) Appl. No.: 12/425,741

(22) Filed: Apr. 17, 2009

Related U.S. Application Data
(60) Provisional application No. 61/046,085, filed on Apr. 18, 2008.

(51) Int. Cl. A61G 17/00

(52) U.S. Cl. 27/1; 119/843

(57) ABSTRACT

A device for transporting animal carcasses, that includes a flexible, durable material, wherein flexible, durable material further includes at least two layers bound to one another, wherein a cavity has been formed at a predetermined location between the layers for receiving an animal carcass, and wherein an opening has been formed in one of the layers for accessing the cavity formed between the layers; and means for sealing the opening formed in one of the layers after an animal carcass has been placed in the cavity formed between the two layers.

### CROSS-REFERENCE TO RELATED APPLICATIONS

This patent application claims the benefit of U.S. Provisional Patent Application Ser. No. 61/046,085 filed on Apr. 18, 2008 and entitled “Cadaver Bag for Animals,” the disclosure of which is incorporated by reference as if fully rewritten herein.

### BACKGROUND OF THE INVENTION

The present invention relates generally to materials and equipment associated with the disposal of biological material, and more specifically to a biodegradable container for use in storing animal carcasses prior to and during disposal thereof.

Many people in this country and around the world keep animals as pets. A particularly unfortunate aspect of pet ownership is the inevitable death of these animals. Once an animal has died, disposal of its remains can be somewhat problematic in that it may challenging and/or unpleasant to transport the remains of the animal to a suitable site for burial. Placing an animal's remains in a sheet, garbage bag, or other container often makes transport of the remains difficult, physically and emotionally, and may create unsanitary or unsafe conditions. Thus, there is a need for a device or apparatus that is suitable for easily, safely, and cleanly transporting animal remain to a suitable location for burial or disposal by other means.

### SUMMARY OF THE INVENTION

The following provides a summary of certain exemplary embodiments of the present invention. This summary is not an extensive overview and is not intended to identify key or critical aspects or elements of the present invention or to delineate its scope.

In accordance with one aspect of the present invention, a device for transporting animal carcasses is provided. This device includes a flexible, durable material, wherein flexible, durable material further includes at least two layers bound to one another, wherein a cavity has been formed at a predetermined location between the layers for receiving an animal carcass, and wherein an opening has been formed in one of the layers for accessing the cavity formed between the layers. A means for sealing the opening formed in one of the layers after an animal carcass has been placed in the cavity formed between the two layers is also provided.

In accordance with another aspect of the present invention, a container for transporting animal carcasses is provided. This container includes a piece of flexible, substantially fluid and gas-impermeable material, wherein this material further includes: a top layer bound to a bottom layer around the edges thereof. The top layer and the bottom layer further define a cavity therebetween for receiving the carcass of an animal. An opening is formed in the top layer of the flexible, substantially fluid and gas-impermeable material for accessing the cavity formed between the top layer and the bottom layer. A zipper or sliding closure means for sealing the opening after an animal carcass has been placed in the cavity formed between the two layers is also provided.

In yet another aspect of this invention, a container for storing and transporting animal carcasses is provided. This container includes a flexible, substantially fluid-impermeable and gas-impermeable material, wherein the flexible, substantially fluid-impermeable and gas-impermeable material further includes: a top layer bound to a bottom layer; wherein the top layer and the bottom layer further define a cavity therebetween for receiving the carcass of an animal; and grasping apertures formed at regular intervals near the outer edges of the piece of flexible, substantially fluid-impermeable and gas-impermeable material for facilitating handling of the container. An opening is formed in the top layer of the flexible, substantially fluid-impermeable and gas-impermeable material for accessing the cavity formed between the top layer and the bottom layer. A closure means for sealing the opening after an animal carcass has been placed in the cavity formed between the two layers.

Additional features and aspects of the present invention will become apparent to those of ordinary skill in the art upon reading and understanding the following detailed description of the exemplary embodiments. As will be appreciated by the skilled artisan, further embodiments of the invention are possible without departing from the scope and spirit of the invention. Accordingly, the drawings and associated descriptions are to be regarded as illustrative and not restrictive in nature.

### BRIEF DESCRIPTION OF THE DRAWINGS

The drawings included herewith, which are incorporated into and form a part of the specification of this patent application, schematically illustrate one or more exemplary embodiments of the invention and together with the description given below serve to explain the principles of the invention, and wherein:

FIG. 1 is an illustration of a first exemplary embodiment of the present invention intended for use with smaller animal carcasses showing the container in an open position prior to the placement of an animal carcass therein.

FIG. 2 is an illustration of a second exemplary embodiment of the present invention intended for use with larger animal carcasses showing the container in an open position prior to the placement of an animal carcass therein.

### DETAILED DESCRIPTION OF THE INVENTION

Exemplary embodiments of the present invention are now described with reference to the Figures. Reference numerals are used throughout the detailed description to refer to the various elements and structures. Although the following detailed description contains many specifics for the purposes of illustration, a person of ordinary skill in the art will appreciate that many variations and alterations to the following details are within the scope of the invention. Accordingly, the following embodiments of the invention are set forth without any loss of generality to, and without imposing limitations upon, the claimed invention.

The present invention relates to a device for storing and transporting biological waste such as animal remains, i.e., corpses, carcasses, and cadavers. As previously indicated, a first general embodiment of this invention provides a device for transporting animal carcasses; a second general embodiment of this invention provides a a container for transporting animal carcasses; and a third general embodiment of this invention provides a container for storing and transporting animal carcasses. With reference now to the Figures, one or more specific embodiments of this invention shall be described in greater detail.

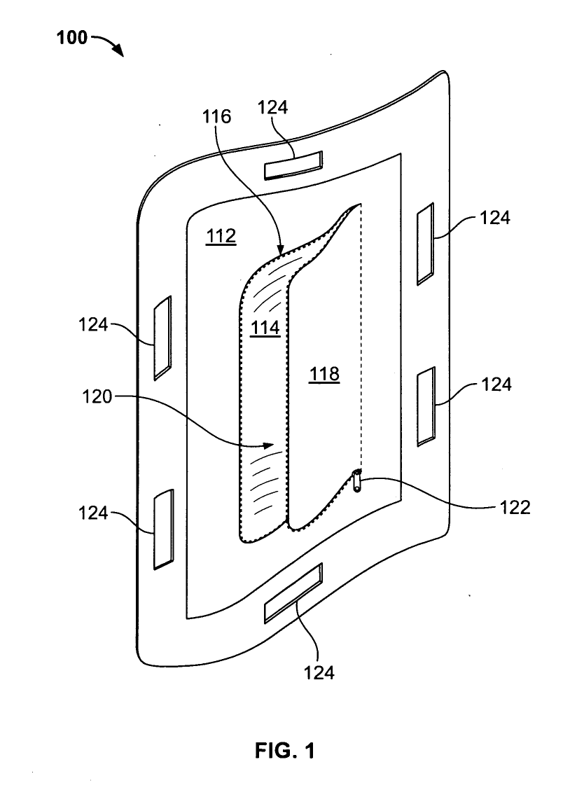

With reference to FIG. 1, a first exemplary embodiment of this invention provides cadaver bag 100, which includes a piece of substantially fluid-impermeable and gas-impermeable material that further includes a top layer 112 and a bottom layer 114. These two layers are bound together at the outer edges thereof by adhesive means or other suitable means known to those of ordinary skill in the art. Top layer 112 and bottom layer 114 are not bound to one another in the center portion of cadaver bag 100, thereby forming a cavity 120 between the two layers. A substantially C-shaped opening 116 is formed in top layer 112, creating flap 118, for permitting access to cavity 120. The C-shaped opening is intended to open away from the user of the bag such that a single person may more easily place a dead animal in the bag. Closure means 122, which may be a zipper, slider, or other closure device, is attached to the edges of opening 116 and permits the user of cadaver bag 100 to seal cavity 120 after an animal carcass has been placed therein. In some embodiments of this invention, cavity 120 (where the deceased animal is placed) is heat sealed or otherwise sealed, lined, or insulated to prevent liquid leakage and decrease odor generated by the bag's contents. The size of cavity 120 is based on the overall size classification of the bag, which in the case of this embodiment is small, for use with smaller animals such as cats or rabbits.

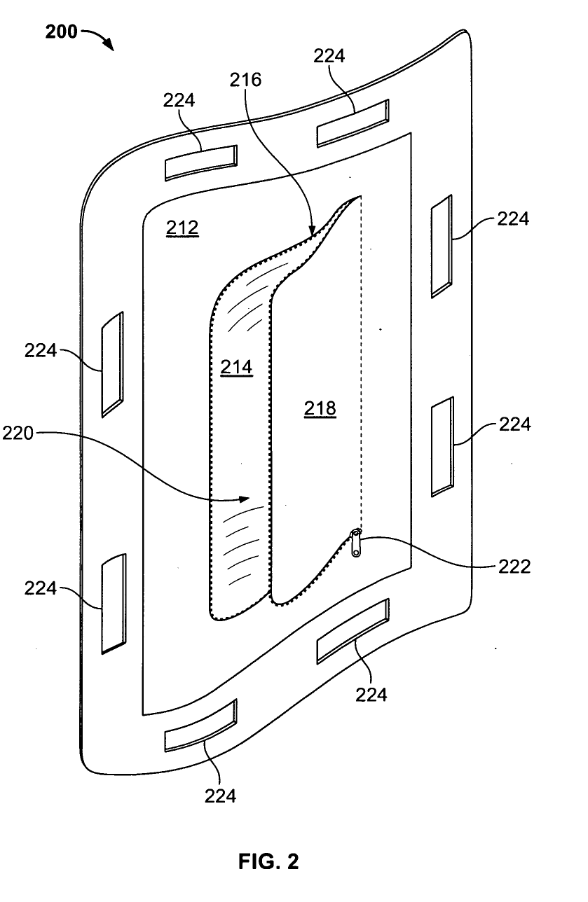

With reference to FIG. 2, a second exemplary embodiment of this invention provides cadaver bag 200, which includes a piece of substantially fluid-impermeable and gas-impermeable material that further includes a top layer 212 and a bottom layer 214. These two layers are bound together at the outer edges thereof by adhesive means or other suitable means known to those of ordinary skill in the art. Top layer 212 and bottom layer 214 are not bound to one another in the center portion of cadaver bag 200, thereby forming a cavity 220 between the two layers. A substantially C-shaped opening 216 is formed in top layer 212, creating flap 218, for permitting access to cavity 220. The C-shaped opening is intended to open away from the user of the bag such that a single person may more easily place a dead animal in the bag. Closure means 222, which may be a zipper, slider, or other closure device, is attached to the edges of opening 216 and permits the user of cadaver bag 200 to seal cavity 220 after an animal carcass has been placed therein. In some embodiments of this invention, cavity 220 (where the deceased animal is placed) is heat sealed or otherwise sealed, lined, or insulated to prevent liquid leakage and decrease odor generated by the bag's contents. The size of cavity 220 is based on the overall size classification of the bag, which in the case of this embodiment is medium to large, for use with larger animals such as dogs.

The cadaver bags of the present invention may be provided in different size classifications: small, medium, and large. Obviously, the size of the animal will dictate which size classification of the bag is appropriate. By way of example, a small-size classification bag will have a cavity measuring one foot in width by two foot in length; a medium-size classification bag will have a cavity measuring two foot in width by three foot in length; and a large-size classification bag will have a cavity measuring three foot in width by four foot in length. All bags are typically constructed from the same material and are designed to haul a predetermined maximum weight.

Cadaver bags 100 and 200 are typically rectangular in shape (although other geometries are possible) and include handles 124 and 224 formed in the material thereof at multiple locations. These handles, which may be placed at the ends of the bag or at the ends and along the sides thereof, provide a convenient means by which the user of the bag may manually transport the bag and its contents. Handles 124 and 224 may be reinforced with additional material for transporting heavier animals and are strategically and conveniently placed to allow for efficient transporting, loading and unloading. A small size classification bag's handles 124 may be located on each end and, optionally, on the sides of the bag (see FIG. 1). Each handle will be directly cut into the bag from the existing material and located between the sealed cavity and the edge of the bag. The medium size classification bag's handles, as well as the large size classification bag, are created using the same or similar design parameters. However, two handles 224 are typically included on each end, as well as multiple handles 224 on each side of the biodegradable animal cadaver bag (see FIG. 2). The handles that are located on each end and side of the medium and large size classification biodegradable animal cadaver bags are typically evenly centered and cut between the sealed cavity and the edge of the bag. The handles that are directly cut into the small, medium, and large size classification bags will accommodate a solo transporter, as well as multiple transporters depending on the size/weight of the animal cadaver. The placement of the handles also allows for an easier or more efficient placement of the animal cadaver and prevents a “sliding/dropping” movement of the animal once in the bag.

In an exemplary embodiment of the present invention, the material from which the container for transporting animal carcasses is manufactured includes at least one biodegradable plastic or bioplastic. The use of such materials will allow the bag to break down or otherwise decompose following burial or disposal. Biodegradable plastics are plastics that decompose in the natural environment. Biodegradation of plastics can be achieved by enabling microorganisms in the environment to metabolize the molecular structure of plastic films to produce an inert humus-like material that is less harmful to the environment. Bioplastics are biodegradable plastics whose components are derived from renewable raw materials. The use of bio-active compounds compounded with swelling agents ensures that, when combined with heat and moisture, they expand the plastic's molecular structure and allow the bio-active compounds to metabolize and neutralize the plastic. Bioplastics are derived from renewable raw materials such as starch (e.g. corn, potato, tapioca etc), cellulose, soy protein, lactic acid etc., not hazardous in production and decompose back to carbon dioxide, water, biomass etc. in the environment when discarded. Corn starch is currently the main raw material being used in the manufacture of bioplastic resins. Mater-Bi (main component corn-starch), and PolyActide (PLA) (made from corn-starch as well) are currently the 2 main resins (raw materials), being used today in the production of compostable and biodegradable plastics and are certified for compostability under standards set by international organizations. However, other resins may be made from potato starch, soybean protein, cellulose etc.

While the present invention has been illustrated by the description of exemplary embodiments thereof, and while the embodiments have been described in certain detail, it is not the intention of the Applicant to restrict or in any way limit the scope of the appended claims to such detail. Additional advantages and modifications will readily appear to those skilled in the art. Therefore, the invention in its broader aspects is not limited to any of the specific details, representative devices and methods, and/or illustrative examples shown and described. Accordingly, departures may be made from such details without departing from the spirit or scope of the applicant's general inventive concept.

What is claimed:

1. A device for transporting animal carcasses, comprising:
(a) a flexible, durable material, wherein flexible, durable material further includes at least two layers bound to one another, wherein a cavity has been formed at a predetermined location between the layers for receiving an animal carcass, and wherein an opening has been formed in one of the layers for accessing the cavity formed between the layers; and
(b) means for sealing the opening formed in one of the layers after an animal carcass has been placed in the cavity formed between the two layers.

2. The device of claim 1, wherein the shape of the device is substantially rectangular.

3. The device of claim 1, wherein grasping apertures have been formed at regular intervals near the outer edges of the flexible, durable material for facilitating handling of the device.

4. The device of claim 1, wherein the flexible durable material is partially or wholly biodegradable.

5. The device of claim 1, wherein the opening is substantially “C” shaped.

6. The device of claim 1, wherein the means for sealing the opening formed in one of the layers further includes a zipper.

7. The device of claim 1, wherein the means for sealing the opening formed in one of the layers further includes a slidable closure means.

8. A container for transporting animal carcasses, comprising:
(a) a flexible, substantially fluid-impermeable and gas-impermeable material, wherein the flexible, substantially fluid-impermeable and gas-impermeable material further includes:
(i) a top layer bound at the edges thereof to a bottom layer;
(ii) wherein the top layer and the bottom layer further define a cavity therebetween for receiving the carcass of an animal; and
(b) an opening formed in the top layer of the flexible, substantially fluid-impermeable and gas-impermeable material for accessing the cavity formed between the top layer and the bottom layer; and
(c) means for sealing the opening after an animal carcass has been placed in the cavity formed between the two layers.

9. The container of claim 8, wherein the shape of the container is substantially rectangular.

10. The container of claim 1, further comprising grasping apertures formed at regular intervals near the outer edges of the piece of flexible, substantially fluid-impermeable and gas-impermeable material for facilitating handling of the container.

11. The container of claim 1, wherein the flexible, substantially fluid-impermeable and gas-impermeable material is partially or wholly biodegradable.

12. The container of claim 1, wherein the opening is substantially “C” shaped.

13. The container of claim 1, wherein the means for sealing the opening formed in the top layer further includes a zipper.

14. The container of claim 1, wherein the means for sealing the opening formed in the top layer further includes a slidable closure means.

15. A container for storing and transporting animal carcasses, comprising:
(a) a flexible, substantially fluid-impermeable and gas-impermeable material, wherein the flexible, substantially fluid-impermeable and gas-impermeable material further includes:
(i) a top layer bound at the edges thereof to a bottom layer; wherein the top layer and the bottom layer further define a cavity therebetween for receiving the carcass of an animal; and
(ii) grasping apertures formed at regular intervals near the outer edges of the piece of flexible, substantially fluid-impermeable and gas-impermeable material for facilitating handling of the container; and
(b) an opening formed in the top layer of the flexible, substantially fluid-impermeable and gas-impermeable material for accessing the cavity formed between the top layer and the bottom layer; and
(c) closure means for sealing the opening after an animal carcass has been placed in the cavity formed between the two layers.

16. The container of claim 15, wherein the shape of the container is substantially rectangular.

17. The container of claim 15, wherein the container is adapted to transport that carcasses of small animals, medium sized animals, or large animals.

18. The container of claim 15, wherein the flexible, substantially fluid-impermeable and gas-impermeable material is partially or wholly biodegradable.

19. The container of claim 15, wherein the opening is substantially “C” shaped.

20. The container of claim 15, wherein the means for sealing the opening formed in the top layer further includes a zipper or a slidable closure means.
